(19) United States
(12) Patent Application Publication
(10) Pub. No.: US 2021/0207390 A1
(43) Pub. Date: Jul. 8, 2021

(54) MEMBER SUPPLY DEVICE

(71) Applicant: Shimizu Corporation, Tokyo (JP)

(72) Inventors: Syunsuke IGARASHI, Tokyo (JP); Taku TANI, Tokyo (JP)

(73) Assignee: Shimizu Corporation, Tokyo (JP)

(21) Appl. No.: 17/059,266

(22) PCT Filed: May 20, 2019
(86) PCT No.: PCT/JP2019/019979

§ 371 Date: Nov. 27, 2020

(30) Foreign Application Priority Data
Jun. 4, 2018 (JP) 2018-107202

(51) Int. Cl. E04G 21/16; B23P 19/00

(52) U.S. Cl. CPC E04G 21/16; B23P 19/006

(57) ABSTRACT

A member supply device including: a storage configured to store members; a lower stopper cylinder including a first rod and an upper stopper cylinder including a second rod, the first rod and the second rod being configured to: sandwich at least one of the members stored in the storage; and stop movement of a member above the first rod and a member above the second rod and position the member above the first rod and the member above the second rod; a receiver provided below the storage, the receiver being configured to receive a member that fell from the storage and guide the member to the outside; and a controller configured to alternately advance and retreat the first rod and the second rod in a horizontal direction such that a predetermined number of the members among the members stored in the storage fall to the receiver.

### FIELD

The present invention relates to a member supply device for supplying members such as hanger bolts to an external device such as an end effector in ceiling construction works of buildings, for example.

### BACKGROUND

In conventional ceiling construction works of buildings, ceiling hanger bolts and ceiling boards are attached to the ceiling. Such construction works are usually executed manually facing upward by workers, using elevated work platform vehicles, scaffolding, or the like. Generally, the number of ceiling hanger bolts to be attached is large, which involves repeating relocation of scaffolding and tightening of bolts at high elevations many times.

In order to reduce the burdens on the workers, the present patent applicant has proposed such a construction work robot as described in Patent Literature 1. This construction work robot inserts a hanger bolt (external thread) into an insert (internal thread), and locks ceiling hanging members.

### CITATION LIST

### Patent Literature

Patent Literature 1: Japanese Patent Application Laid-open No. 2017-110466

### SUMMARY

### Technical Problem

For greater efficiency of work executed by the construction work robot described in Patent Literature 1 above, the present inventors have considered providing, to the tip of a manipulator of the construction work robot, a mechanism (end effector) for gripping and inserting a hanger bolt into the insert. An ability to supply the hanger bolt to a gripping means of the end effector with speed and reliability shortens time for attaching the hanger bolt and enables efficient execution of work, and is thus preferable. As a result, a device that is able to supply hanger bolts with speed and reliability has been desired.

The present invention is made in view of the foregoing, and it is an object of the present invention to provide a device that is able to supply a member with speed and reliability.

### Solution to Problem

To solve the problem and achieve the object, a member supply device configured to supply members stored therein to an outside according to the present invention includes: a storage means configured to arrange and store members in a vertical direction; positioning means provided one above another sandwiching at least one of the members stored in the storage means, the positioning means being configured to stop movement of a member thereabove and position the member thereabove; a receiving means provided below the storage means, the receiving means being configured to receive a member that fell from the storage means and guide the member that fell from the storage means to the outside; and a controlling means configured to alternately advance and retreat the upper and lower positioning means in a horizontal direction such that a predetermined number of the members among the members stored in the storage means fall to the receiving means.

Moreover, in the member supply device according to the present invention, the receiving means is made up of a tilt stand configured to tilt downward toward the outside, the tilt stand including a recessed portion for inserting and locating therein a device to which members are supplied, and the recessed portion is provided at an end portion of the tilt stand closer to the outside.

Moreover, in the member supply device according to the present invention, the receiving means is made up of a tilt stand configured to tilt downward toward the outside, the tilt stand including a retaining unit configured to temporarily retain the members, and the retaining unit is provided at an end portion of the tilt stand closer to the outside.

Moreover, the member supply device according to the present invention further includes a positioning unit configured to move a member retained in the retaining unit along the retaining unit and position the member.

Moreover, in the member supply device according to the present invention, a plurality of the storage means are provided along a tilt direction of the tilt stand.

### Advantageous Effects of Invention

With the member supply device according to the present invention, the member supply device is a device for supplying members stored therein to the outside, and the device includes: a storage means configured to arrange and store therein members in the vertical direction; positioning means arranged one above the other sandwiching at least one of the members stored in the storage means, the positioning means being configured to stop movement of a member thereabove and position the member; a receiving means provided below the storage means, the receiving means being configured to receive a member having fallen from the storage means and guide the member to the outside; and a controlling means configured to cause the upper and lower positioning means to alternately advance and retreat in the horizontal direction so as to cause a predetermined number of the members among the members stored in the storage means to fall to the receiving means. Alternately advancing and retreating the upper and lower positioning means such that the predetermined number of the members among the members stored in the storage means fall to the receiving means enables the members to be supplied to an external end effector or the like with speed and reliability. Consequently, it is possible to shorten the time for attaching members by way of the end effector or the like and provide efficient execution of work.

With a member supply device according to the present invention, the receiving means is made up of a tilt stand that is tilted downward toward the outside, and the tilt stand has, at the end thereof closer to the outside, a recessed portion provided for inserting and locating therein a device to which members are supplied that is a supply destination of the members. Thus, it is possible to supply a member that has slid down the tilt stand to the device to which members are supplied, such as an end effector that has been inserted and located in the recessed portion, with reliability.

With another member supply device according to the present invention, the receiving means is made up of a tilt stand that is tilted downward toward the outside, and the tilt stand has, at the end thereof closer to the outside, a retaining unit provided for temporarily retaining the members. Thus, it is possible to temporarily retain, in the retaining unit, a member that has slid down the tilt stand.

With another member supply device according to the present invention, a positioning unit is included, the positioning unit being configured to move a member retained in the retaining unit along the retaining unit and position the member, enabling position adjustments of the member in the retaining unit. Thus, it is possible to adjust relative position of the member with respect to a device to which members are supplied, such as an end effector that is on standby near the retaining unit.

With another member supply device according to the present invention, a plurality of the storage means are arranged along the tilt direction of the tilt stand. Thus, it is possible to store many various members and also supplying appropriate members.

### BRIEF DESCRIPTION OF DRAWINGS

FIG. 1 is a front view illustrating a member supply device according to an embodiment of the present invention.

FIG. 2 is a top view illustrating the member supply device according to the embodiment of the present invention.

FIG. 3 is a sectional view taken along line A-A in FIG. 1.

FIG. 4(1) is a partially enlarged sectional view taken along line B-B in FIG. 1, FIG. 4(2) is a partially enlarged sectional view taken along line C-C in FIG. 1.

FIG. 5 is a view illustrating a procedure for falling from storage positions.

### DESCRIPTION OF EMBODIMENTS

A member supply device according to an embodiment of the present invention will be described below in detail with reference to the drawings. The embodiment does not limit the present invention.

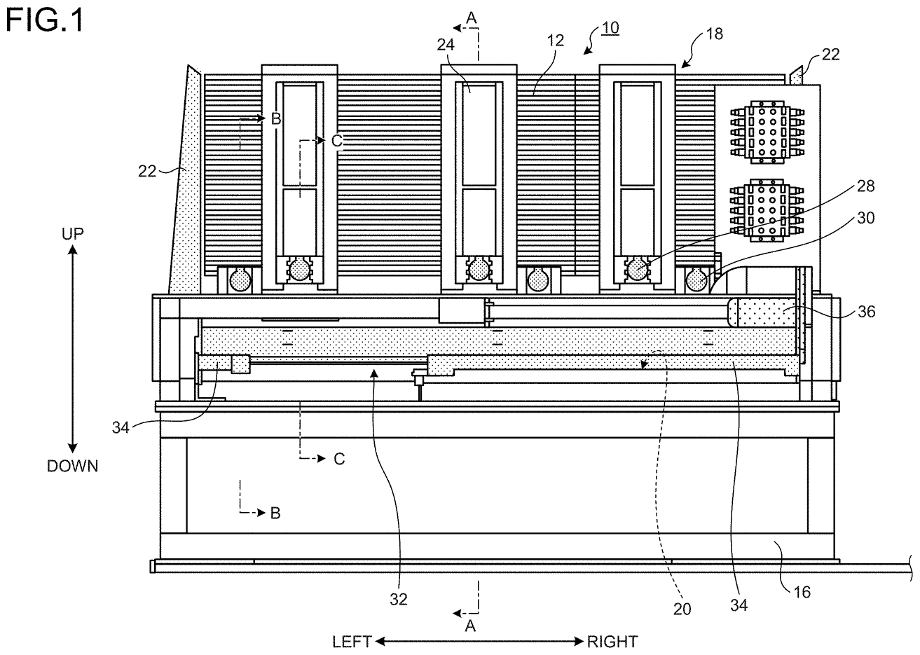

As illustrated in FIG. 1 to FIG. 3, a member supply device 10 according to the present embodiment is a device for supplying hanger bolts 12 (members) stored therein to an external end effector 14 (device to which members are supplied). The member supply device 10 includes a base 16, hanger bolt storages 18 (storage means) provided on the top face of the base 16, and a tilt stand 20 (receiving means) provided in the interior of the base 16.

The hanger bolt storages 18 store therein the hanger bolts 12, which are rod-shaped members being long in the left-and-right direction, in such a manner that the hanger bolts 12 are arranged in the up-and-down direction, and five hanger bolt storages 18 are arranged in the front-and-back direction with spacing therebetween. The hanger bolt storages 18 each include wall-like frames 22 provided to the left and right ends, and wall-like supports 24 arranged to face each other on the front and rear faces with spacing therebetween in the left-and-right direction. The front and rear supports 24 are arranged to face each other with spacing slightly larger than the diameter of the hanger bolts 12, and the hanger bolts 12 are arranged and stored in the up-and-down direction in a vertical passage 26 that is a clearance between the supports 24. When storing the hanger bolts 12, the hanger bolts 12 are dropped sideways into the vertical passage 26 one by one from the top of the clearance between the supports 24. In this manner, the hanger bolts 12 are arranged and stored in the up-and-down direction.

In the underside of each of the hanger bolt storages 18, a plurality of stopper cylinders 28, 30 (positioning means) are provided at different heights. In the present embodiment, the stopper cylinders include a stopper cylinder 28 provided in the lower part of the supports 24 and a stopper cylinder 30 provided on the top face of the nearby base 16 on the left or right side of the stopper cylinder 28. The stopper cylinder 28 is located in the upper side, and the stopper cylinder 30 is located slightly lower than the stopper cylinder 28.

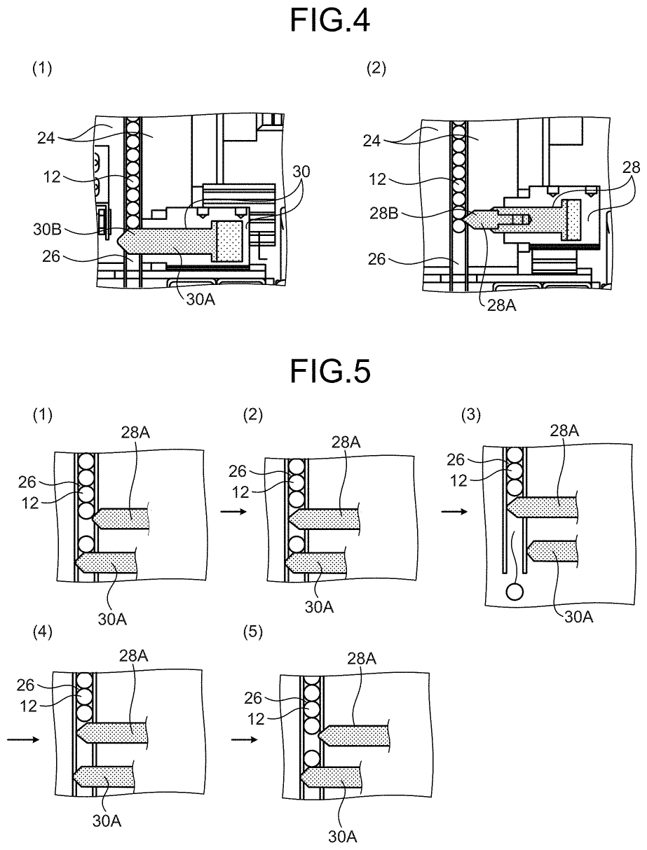

As illustrated in FIG. 4(1) and FIG. 4(2), rods 28A, 30A of the stopper cylinders 28, 30 project rearward from the respective rear ends of the cylinders, and are able to advance or retreat in the front-and-back direction under the control of a controlling means, which is not illustrated. The rods 28A, 30A have pointed claws 28B, 30B formed at the respective tips thereof. Advancing the rods 28A, 30A in the back direction causes the claws 28B, 30B to be inserted between a hanger bolt 12, thereby stopping the hanger bolts 12 above the claws 28B, 30B from falling to effect positioning. By contrast, retracting the rods 28A, 30A in the front direction causes the hanger bolts 12 to fall under their own weight.

The spacing in the up-and-down direction between the claw 28B of the rod 28A of the upper stopper cylinder 28 and the claw 30B of the rod 30A of the lower stopper cylinder 30 is slightly wider than the diameter of the hanger bolts 12. Thus, alternately advancing and retreating the upper and lower rods 28A, 30A in the front-and-back direction enables the hanger bolts to fall one by one to the tilt stand 20 below the rods.

Operations to be performed when the hanger bolts fall will now be described in more details. As illustrated in FIG. 5(1), first, the lower rod 30A is extended backward to be located under the hanger bolt 12, and the upper rod 28A is also contracted and retracted so as not to be interposed between the hanger bolts 12. In this state, the hanger bolts 12 above the rod 30A are restrained from moving, and thus do not fall. Subsequently, as illustrated in FIG. 5(2), the upper rod 28A is extended backward to be inserted between the hanger bolts 12, so that the single hanger bolt 12 is sandwiched between the upper and lower rods 28A, 30A. As illustrated in FIG. 5(3), the lower rod 30A is then contracted, so that the single hanger bolt 12 on top thereof falls under its own weight. At this time, the hanger bolts 12 above the upper rod 28A are restrained from moving, and thus do not fall. Thereafter, as illustrated in FIG. 5(4), the lower rod 30A is extended backward, and then, as illustrated in FIG. 5(5), the upper rod 28A is contracted and retracted. In this manner, the hanger bolt 12 located above the upper rod 28A falls and stops above the lower rod 30A. From this point onward, operations illustrated in FIG. 5(1) to FIG. 5(5) may be repeated every time the hanger bolt is supplied.

As illustrated in FIG. 1 to FIG. 3, the tilt stand 20 is provided below the hanger bolt storages 18, and receives the hanger bolts 12 that have fallen from the hanger bolt storages 18 and guides them to the outside. The tilt stand 20 is tilted downward toward the front (the outside). The tilt stand 20 has a length in the left-and-right direction nearly equal to the length of the hanger bolt storages 18 in the left-and-right direction, and has a length sufficient to cover the length of the five hanger bolt storages 18 in the front-and-back direction. The tilt stand 20 has, in the portion of the front end to the left, a dented recessed portion 32 provided for inserting and locating therein the end effector 14 (device to which members are supplied) that is a supply destination.

The tilt stand 20 has, at the front end thereof, a hook-like fold 34 (retaining unit) provided for temporarily retaining the hanger bolts 12. The tilt stand 20 also has, at the right end on the front end side thereof, a positioning unit 36 provided for positioning the hanger bolts 12. The positioning unit 36 adjust the relative position of the hanger bolt 12 with respect to the end effector 14 on standby in the recessed portion 32 on the left side, and is movable along the tilt stand 20 in the left-and-right direction. The relative position of the hanger bolt 12 with respect to the end effector 14 may be adjusted by the positioning unit 36 pushing the right end of the hanger bolt 12 retained in the fold 34 in the left direction to move the hanger bolt 12 by a desired distance in the left direction, for example. This operation enables fine adjustments of the position for supplying the hanger bolt 12 relative to the end effector 14. This operation also facilitates positioning of the hanger bolt relative to the end effector 14 in a case in which the stored hanger bolt 12 is shorter than the tilt stand 20 in the left-and-right direction.

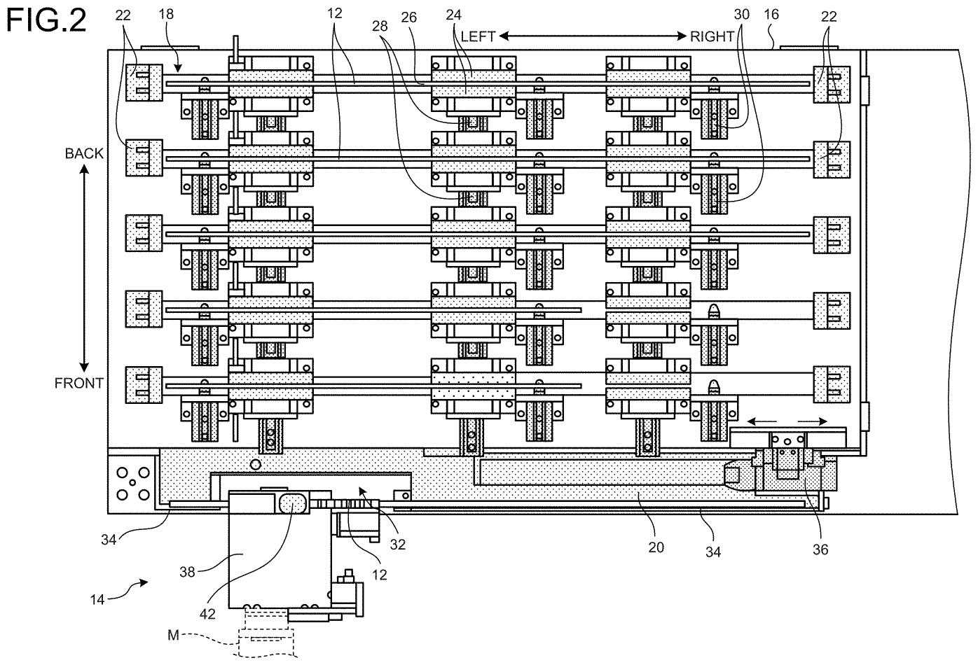

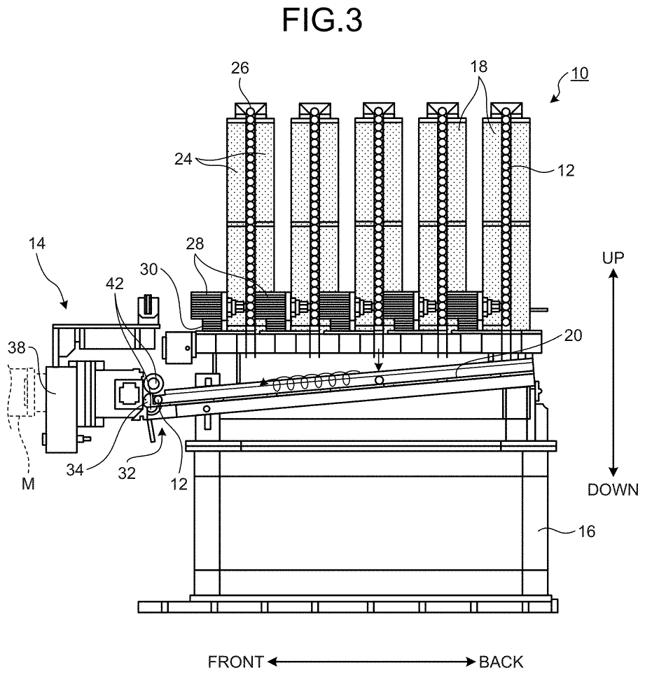

As illustrated in FIG. 2 and FIG. 3, the end effector 14 is inserted and located in the recessed portion 32 each time so as to be supplied with the hanger bolts 12. The end effector 14 includes a main body 38 to be attached to the tip of a manipulator M of a construction work robot, which is not illustrated, and a gripping means 40 provided to the main body 38. The gripping means 40 is made up of two holding rollers 42 closely arranged axially in parallel with each other, and a drive roller 44.

While the end effector 14 is inserted in the recessed portion 32 and is placed on standby, one hanger bolt 12 is caused to fall from the corresponding hanger bolt storage 18, and then the hanger bolt 12 rolls across the tilt stand 20, and is retained in the fold 34. The hanger bolt 12 gets into the gripping means 40 of the end effector 14 at the recessed portion 32, and is then located between the two holding rollers 42 and the drive roller 44 in parallel with the axis thereof. This operation enables the hanger bolt 12 to be supplied to the end effector 14. Operating the end effector 14 in this state and bringing the two holding rollers 42 closer to each other in the direction vertical to the axis thereof causes the three sides, the two holding rollers 42 and the drive roller 44, to sandwich and grip the outer peripheral surface of the hanger bolt 12.

Operations and effects of the constitutions mentioned above will now be described.

The rods 28A, 30A of the stopper cylinders 28, 30 are alternately moved in the front-and-back direction, and the hanger bolts 12 stored in the hanger bolt storages 18 fall one by one. The hanger bolt 12 that has fallen into the tilt stand 20 rolls along the tilt to the front end, and is temporarily stopped at the fold 34. The positioning unit 36 may be moved in the left-and-right direction to move the hanger bolt 12 in the left-and-right direction, and position the hanger bolt 12, as necessary. Thereafter, the manipulator M is operated and the end effector 14 is inserted in the recessed portion 32, and the hanger bolt 12 is gripped by the gripping means 40.

In this manner, according to the present embodiment, the hanger bolts 12 are caused to fall one by one from the storage positions and are supplied to the outside in such a manner as to be retained at a fixed position, and thus the end effector 14 is able to easily grip the supplied hanger bolts 12. Consequently, it is possible to shorten the time between when the hanger bolts 12 are at the respective storage positions and when the hanger bolts 12 are gripped, thereby enabling the construction work robot to efficiently attach the hanger bolts. This can provide power-savings and labor-savings in construction work.

As described above, with a member supply device according to the present invention, the member supply device is a device for supplying members stored therein to the outside, and the device includes: a storage means configured to arrange and store therein members in the up-and-down direction; positioning means arranged one above the other sandwiching at least one of the members stored in the storage means, the positioning means being configured to stop movement of a member thereabove and position the member; a receiving means provided below the storage means, the receiving means being configured to receive a member having fallen from the storage means and guide the member to the outside; and a controlling means configured to cause the upper and lower positioning means to alternately advance and retreat in the horizontal direction so as to cause a predetermined number of the members among the members stored in the storage means to fall to the receiving means. Alternately advancing and retreating the upper and lower positioning means to cause the predetermined number of the members among the members stored in the storage means to fall to the receiving means enables the members to be supplied to an external end effector or the like with speed and reliability. Consequently, time for attaching members by way of the end effector or the like is shortened and efficient execution of work is possible.

With another member supply device according to the present invention, the receiving means is made up of a tilt stand that is tilted downward toward the outside, and the tilt stand has, at the end thereof closer to the outside, a recessed portion provided for inserting and locating therein a device to which members are supplied that is a supply destination of the members. Thus, a member that has slid down the tilt stand can be supplied with reliability to the device to which members are supplied, such as an end effector that has been inserted and located in the recessed portion.

With another member supply device according to the present invention, the receiving means is made up of a tilt stand that is tilted downward toward the outside, and the tilt stand has, at the end thereof closer to the outside, a retaining unit provided for temporarily retaining the members. Thus, a member that has slid down the tilt stand can be temporarily retained in the retaining unit.

With another member supply device according to the present invention, a positioning unit is included, and the positioning unit is configured to move a member retained in the retaining unit along the retaining unit and position the member, thereby enabling position adjustments of the member in the retaining unit. Thus, relative position of the member can be adjusted with respect to a device to which members are supplied, such as an end effector that is on standby near the retaining unit.

With another member supply device according to the present invention, a plurality of the storage means are arranged along the tilt direction of the tilt stand. Thus, many various members can be stored and appropriate members can also be supplied.

### INDUSTRIAL APPLICABILITY

As described above, a member supply device according to the present invention is useful in, when hanger bolts are attached in ceiling construction works of buildings, supplying the hanger bolts to a gripping means, such as an end effector, and is suitable for supplying the hanger bolts with speed and reliability in particular.

### REFERENCE SIGNS LIST

10 member supply device
12 hanger bolt (member)
14 end effector (device to which members are supplied)
16 base
18 hanger bolt storage (storage means)
20 tilt stand (receiving means)
22 frame
24 support
26 vertical passage
28, 30 stopper cylinders (positioning means)
28A, 30A rods
28B, 30B claws
32 recessed portion
34 fold (retaining unit)
36 positioning unit
38 end effector main body
40 gripping means
42 holding roller
44 drive roller
M manipulator

1.-5. (canceled)

6. A member supply device configured to supply members stored therein to an outside, the member supply device comprising:
a storage configured to arrange and store members in a vertical direction;
a lower stopper cylinder including a first rod and an upper stopper cylinder including a second rod, the upper stopper cylinder being provided above the lower stopper cylinder, the first rod and the second rod being configured to:
sandwich at least one of the members stored in the storage; and
stop movement of a member above the first rod and a member above the second rod and position the member above the first rod and the member above the second rod;
a receiver provided below the storage, the receiver being configured to receive a member that fell from the storage and guide the member that fell from the storage to the outside; and
a controller configured to alternately advance and retreat the first rod and the second rod in a horizontal direction such that a predetermined number of the members among the members stored in the storage fall to the receiver.

7. The member supply device according to claim 6, wherein the receiver is made up of a tilt stand configured to tilt downward toward the outside, the tilt stand including a recessed portion for inserting and locating therein a device to which members are supplied, and the recessed portion is provided at an end portion of the tilt stand closer to the outside.

8. The member supply device according to claim 6, wherein the receiver is made up of a tilt stand configured to tilt downward toward the outside, the tilt stand including a retainer configured to temporarily retain the members, and the retainer is provided at an end portion of the tilt stand closer to the outside.

9. The member supply device according to claim 7, wherein the receiver is made up of a tilt stand configured to tilt downward toward the outside, the tilt stand including a retainer configured to temporarily retain the members, and the retainer is provided at an end portion of the tilt stand closer to the outside.

10. The member supply device according to claim 8, further comprising a position adjuster configured to move a member retained in the retainer along the retainer and adjust position of the member.

11. The member supply device according to claim 9, further comprising a positioner adjuster configured to move a member retained in the retainer along the retainer and adjust position of the member.

12. The member supply device according to claim 7, wherein a plurality of the storages are provided along a tilt direction of the tilt stand.

13. The member supply device according to claim 8, wherein a plurality of the storages are provided along a tilt direction of the tilt stand.

14. The member supply device according to claim 9, wherein a plurality of the storages are provided along a tilt direction of the tilt stand.

15. The member supply device according to claim 10, wherein a plurality of the storages are provided along a tilt direction of the tilt stand.

16. The member supply device according to claim 11, wherein a plurality of the storages are provided along a tilt direction of the tilt stand.
